(19) United States
(12) Patent Application Publication
(10) Pub. No.: US 2011/0210152 A1
(43) Pub. Date: Sep. 1, 2011

(54) Receiver Mounted Cargo Carrier System

(76) Inventor: Marty Williams, Colorado Springs, CO (US)

(21) Appl. No.: 11/767,166

(22) Filed: Jun. 22, 2007

(51) Int. Cl. B60R 9/00

(52) U.S. Cl. 224/400

(57) ABSTRACT

A cargo carrier system for mounting to the receiver hitch of a vehicle. The cargo carrier system is formed from a plurality of shaped tubes mounted onto a shank member. The components are able to be shipped in a knock down manner for shipping on standard carriers. The components are easily assembled to form a high strength, lightweight cargo carrier that is mountable onto the receiver hitch of a vehicle. A ramp system is formed in a similar manner that can be mounted onto the cargo carrier.

### FIELD OF THE INVENTION

This invention relates to vehicle cargo carrier systems and more particularly to cargo carrier systems mountable to vehicle hitch receivers.

### BACKGROUND OF THE INVENTION

Cargo carriers have a long history for use with vehicles to increase the cargo capacity of the vehicles. These cargo carriers include roof top carriers, trunk mounted carriers, bumper mounted carriers, trailers, ball mounted carriers and receiver mounted carriers. Receiver mounted carriers have become increasingly popular as able to handle greater capacity of loads, and for ease of mounting and removing onto the vehicles. These types of cargo carriers typically include a shank for insertion into the hitch receiver of the vehicle, locking pins for securing the shank with the hitch receiver and a platform mounted on the shank for holding the cargo.

Problems with these types of carriers are primarily due to the weight and cumbersome nature of these carriers. The platforms are typically either sheet metal or metal grates welded to an angle iron frame which is welded onto cross members which are then welded onto the shank. These systems are relatively heavy which creates problems with installing and removing from the vehicle. Also, the permanent construction of the carriers create problems with shipping, inventory and storage of these units.

Another problem is that it is often necessary to transport a wheeled vehicle, such as a wheel chair, personal mobility scooter, motorcycle, all terrain vehicle, lawn mower or other types of devices. These devices are relatively heavy and cumbersome so in order to use a cargo carrier, it is necessary to have some sort of ramp. Previous ramps tend to be cumbersome and heavy so they are not particularly effective.

Thus a need exists for a receiver mounted cargo carrier that is lightweight, easily portable, easily disassembled for storage and shipping yet is high strength and able to cargo a relatively large amount of cargo.

### SUMMARY OF THE INVENTION

The present invention provides a cargo carrier system that solves these and other problems. The present invention provides a high strength cargo carrier system that is easily assembled so that it can be stored and shipped in a knock-down configuration and then assembled by the purchaser. The assembled system is high strength to carry a substantial load, but is easily installed and removed.

The cargo carrier system of a preferred embodiment includes a plurality of tubes that are secured to the shank member of the cargo carrier system. These tubes form the framework of the platform of the cargo carrier. Panels are then mounted to the tubes to create a solid platform. This assembled system, while high strength, is also relatively light weight so that it can be easily handled.

The cargo carrier system, in a preferred embodiment, includes components that can be easily shipped with standard carriers. These components are easily assembled so that the end user can take delivery and assemble with minimal technical skills or tools required. This allows the systems to be inventoried without taking up substantial valuable warehouse or display space.

The present invention in a preferred embodiment also includes a ramp system that can be used in connection with a cargo carrier system or with separate utility for other applications. The ramp system of this preferred embodiment includes a plurality of tubs that are assembled to create a framework. Panels are secured to this frame work to create a lightweight, high strength ramp. The ramp can be provided with hinges for securing to a cargo carrier system or used separately.

These and other features of the present invention are evident from the ensuing detailed description of preferred embodiments and from the drawings.

### BRIEF DESCRIPTION OF THE DRAWINGS

FIG. 1 is a perspective view of the assembled cargo carrier system of a preferred embodiment of the present invention.

FIG. 2 is a perspective view of the carrier system of the embodiment of FIG. 1 in an exploded assembly view.

FIG. 3 is a perspective view of a partial assembly of the embodiment of FIG. 1.

FIG. 4 is a perspective view of a partial assembly of the embodiment of FIG. 1.

FIG. 5 is a view of the final platform assembly step of the embodiment of FIG. 1.

FIG. 6 is a view of the side rail assembly of the embodiment of FIG. 1.

FIG. 7 is a detail view of the pin nut assembly of the embodiment of FIG. 1.

FIG. 8 is a cross sectional view of the pin nut assembly of the embodiment of FIG. 7.

FIG. 9 is a side view of the embodiment of FIG. 7.

FIG. 10 is a cross sectional view of the embodiment of FIG. 7.

FIG. 11 is a view of the embodiment of FIG. 7.

FIG. 12 is a view of another pin nut embodiment.

FIG. 13 is another view of the embodiment of FIG. 12.

FIG. 14 is a detail view of the side rail assembly of the embodiment of FIG. 1.

FIG. 15 is a view of the end rail assembly of the embodiment of FIG. 1.

FIG. 16 is a view of the end cap assembly of the embodiment of FIG. 1.

FIG. 17 is a perspective view of the ramp system of a preferred embodiment of the present invention.

FIG. 18 is view of the ramp system of FIG. 17 in an exploded assembly view.

FIG. 19 is a view of the ramp system in a partial assembly.

FIG. 20 is a partial assembly view of the ramp system.

FIG. 21 is a partial assembly view of the panels on the ramp system.

FIG. 22 is an assembly view of the ramp system of the embodiment of FIG. 10 mounting onto the carrier system of the embodiment of FIG. 1.

FIG. 23 is a detail view of the latch system of a preferred embodiment of the present invention.

FIG. 24 is a perspective view of the ramp system mounted onto the carrier system.

### DETAILED DESCRIPTION OF PREFERRED EMBODIMENTS

The present invention, in a preferred embodiment, provides an improved cargo carrier systems for mounting to a vehicle. A preferred embodiment of the present invention is described below. It is to be expressly understood that this descriptive embodiment is provided for explanatory purposes only, and is not meant to unduly limit the scope of the present invention as set forth in the claims. Other embodiments of the present invention are considered to be within the scope of the claimed inventions, including not only those embodiments that would be within the scope of one skilled in the art, but also as encompassed in technology developed in the future.

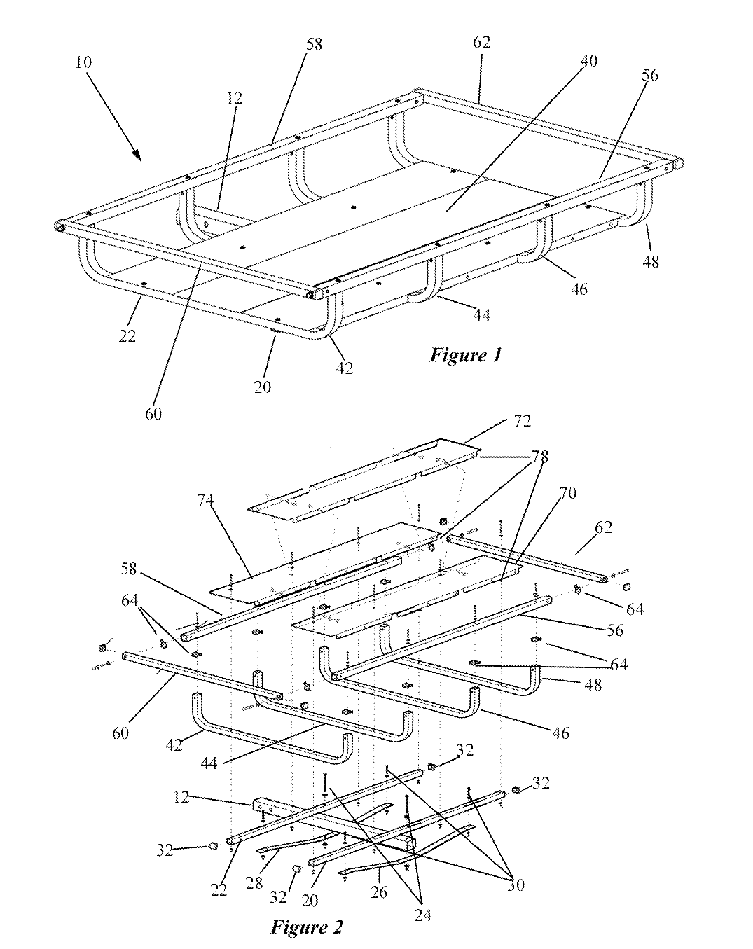

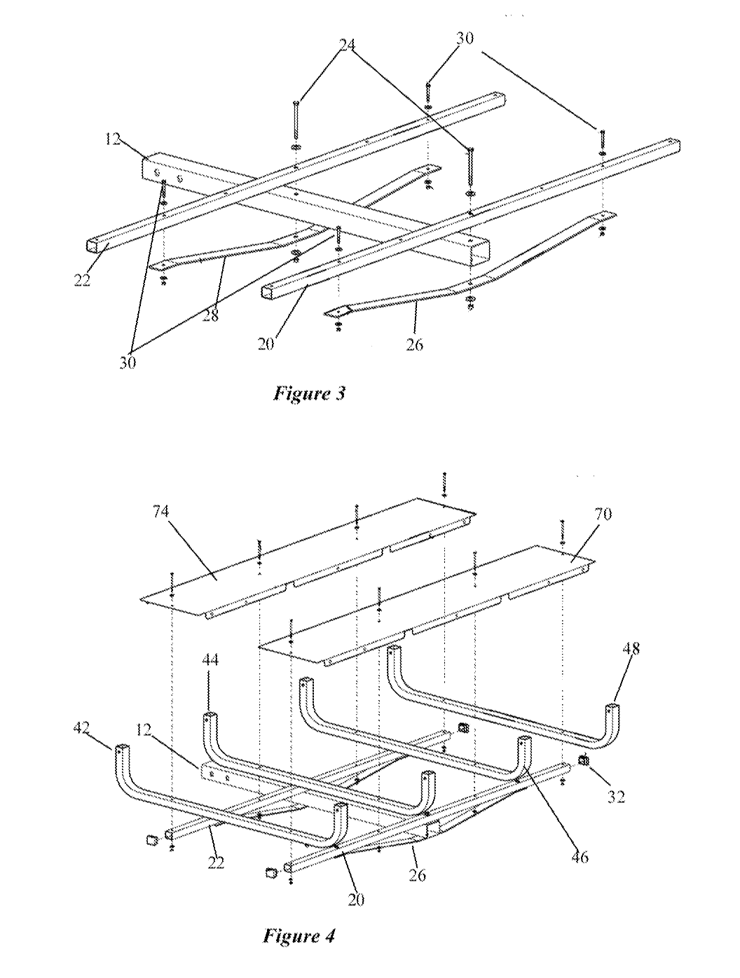

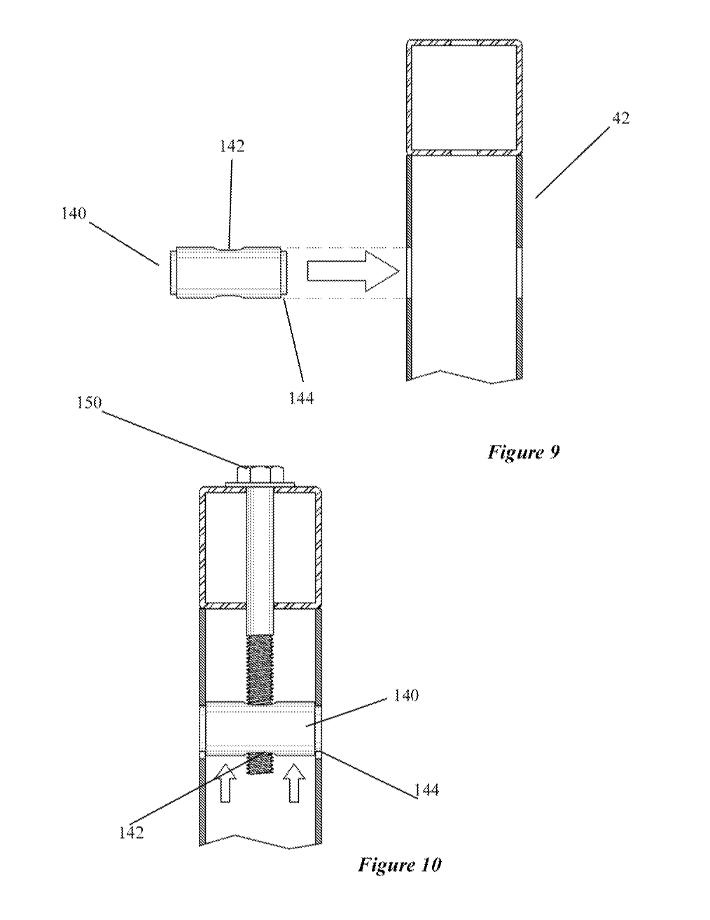

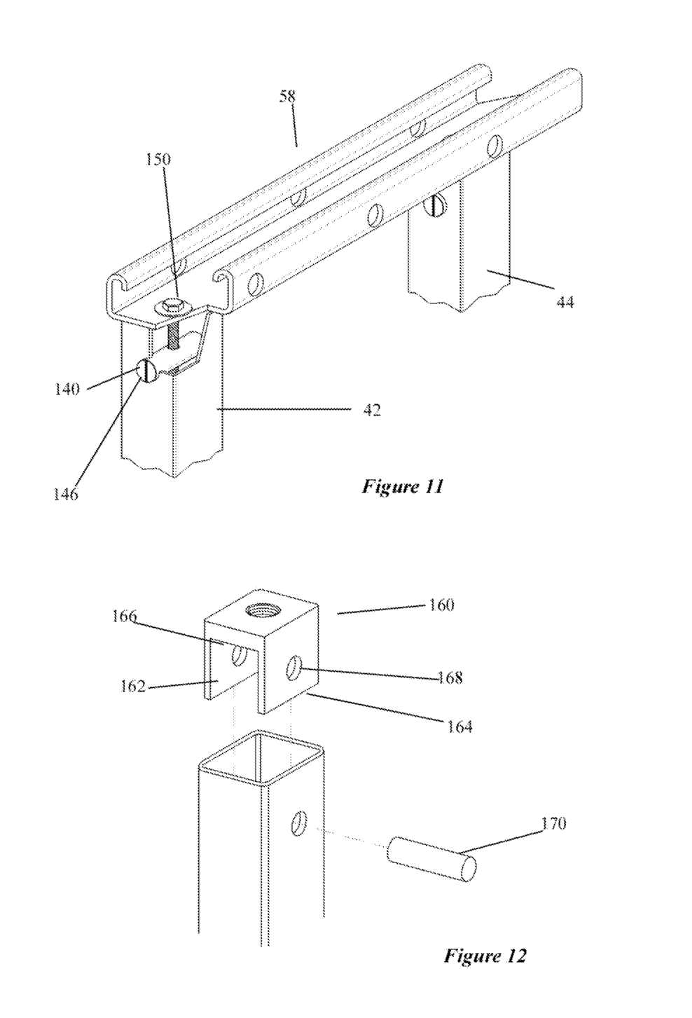

A preferred embodiment of a cargo carrier system of the present invention is illustrated in FIGS. 1-12. This preferred embodiment is described for use with a receiver hitch on a vehicle but other types of attachment systems may be used as well with the present invention.

The cargo carrier system 10 of a preferred embodiment, as shown in FIGS. 1-4 includes a shank member 12 that is slidably received in the receiver hitch of the vehicle. At this time, receiver hitches are standardized in differing sizes, most typically either Class I, 1 inch square or Class II, 2 inch square tubular. Other types may be used as well. The shank member 12 can be selected in the appropriate size for the selected receiver hitch. Pin bolt 14 is used to secure the shank member 10 to the receiver hitch.

Cross members 20, 22 are secured to shank member 12 by pins or bolts 24. Alternatively the cross members 20, 22 may be permanently secured by welding or other attachment in other embodiments. The cross members 20, 22 are secured transversely to the shank member. The lengths of the shank member and cross members are sized to accommodate the size of the platform 40 of the cargo system as discussed in greater detail below. Reinforcement members 26, 28 are secured to the ends of the cross members 20, 22 respectively and to the shank member 12 by bolts or pins 30. Caps 32 may be inserted into the ends of cross members 20, 22.

Platform tube members 42, 44, 46, 48 are mounted to the cross members 20, 22 by bolts or pins 50 parallel to the shank member 12 and spaced from one another. In this preferred embodiment, the tubes 42, 44, 46, 48 are fabricated from standard hollow steel tubing, preferably one-half inch to one inch square tubing. It is to be expressly understood that other sizes of tubing, types of tubing, such as C or U shaped tubing and even materials, such as high strength plastic can be used as well. In this preferred embodiment, the tubes are fabricated into a U shape, as shown in the FIGS. 1-4. In other preferred embodiments, the tubes may be fabricated in a straight shape, or with taller U-shaped portions.

Side tube members 56, 58 are mounted to the upper portions 54 of the U-shaped platform tube members 42, 44, 46, 48. In this preferred embodiment, the side tubes 56, 58 are secured to the tube members by bolts with pin nuts in the tube members or by other attachment mechanisms. End tube members 60, 62 are secured to the ends of the side tubes 56, 58 in a similar manner. Sealing gaskets 64 may also be used to form a tight seal between the platform tube members 42, 44, 46, 48, side tube members 56, 58 and end tube members 60, 62.

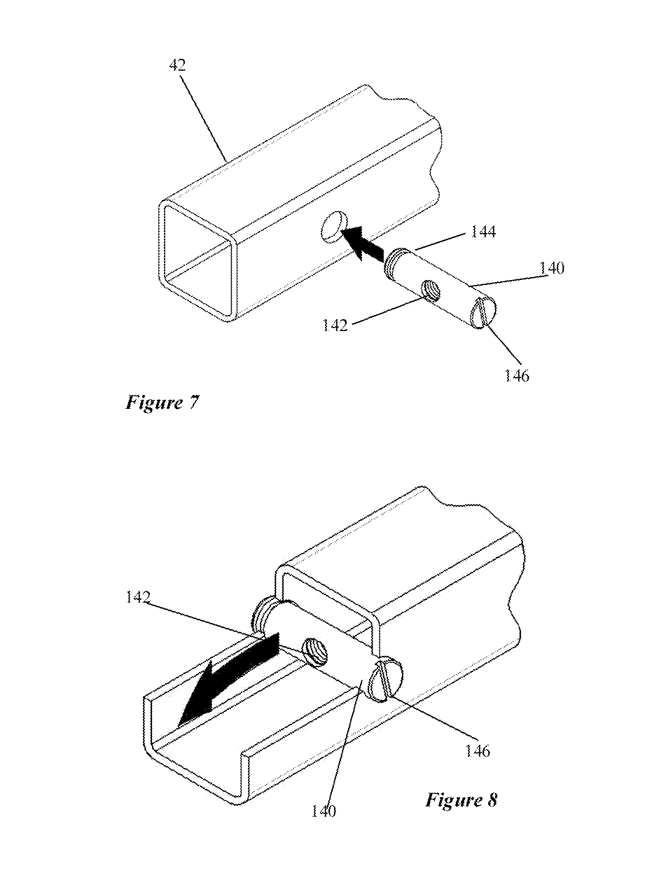

In a preferred embodiment, the side tube members 56, 58 are mounted to the tube members 42, 44, 46, 48 by pin nuts 140, as shown in FIGS. 7-11. The pin nuts 140 are cylindrical members with a threaded center portion 142, a groove 144 adjacent one end and a slot 146 on the opposing end. The pin nut 140 is inserted into a hole in the tube member 42 until the groove 144 engages in the hole on the other side of the tube member 42. Bolt 150 is inserted through a hole in the side tube member 56 and into the open end of the tube member 42 until it engages the threaded portion 142 of the pin nut. A screwdriver can be used to engage the slot 146 of the pin nut to orient the pin nut in proper orientation. The bolt 150 is then rotated to engage in the threads of the pin nut until the side tube is securely attached to the platform tube. The force of this engagement will ensure that the groove 144 of the pin nut is securely engaged in the hole of the platform tube member 42 to prevent the pin nut from disengaging from the tube member.

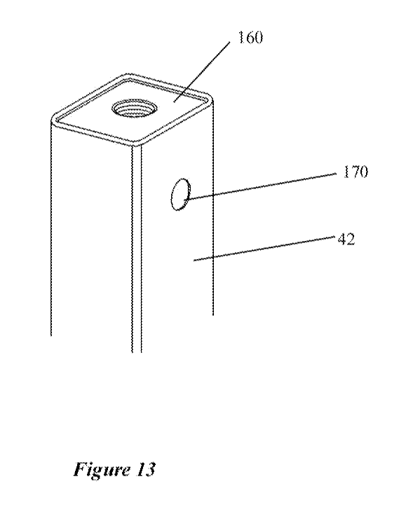

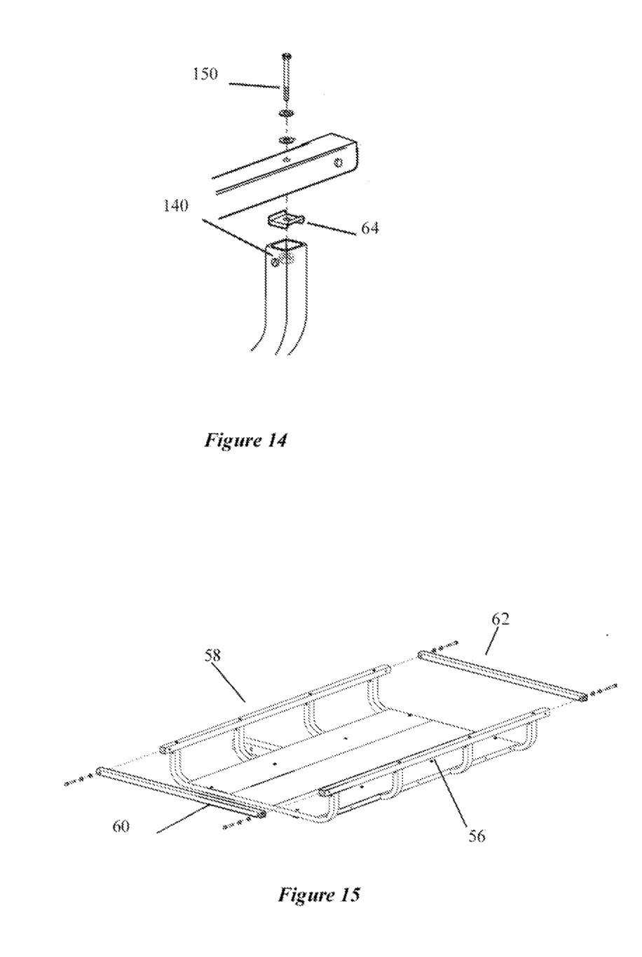

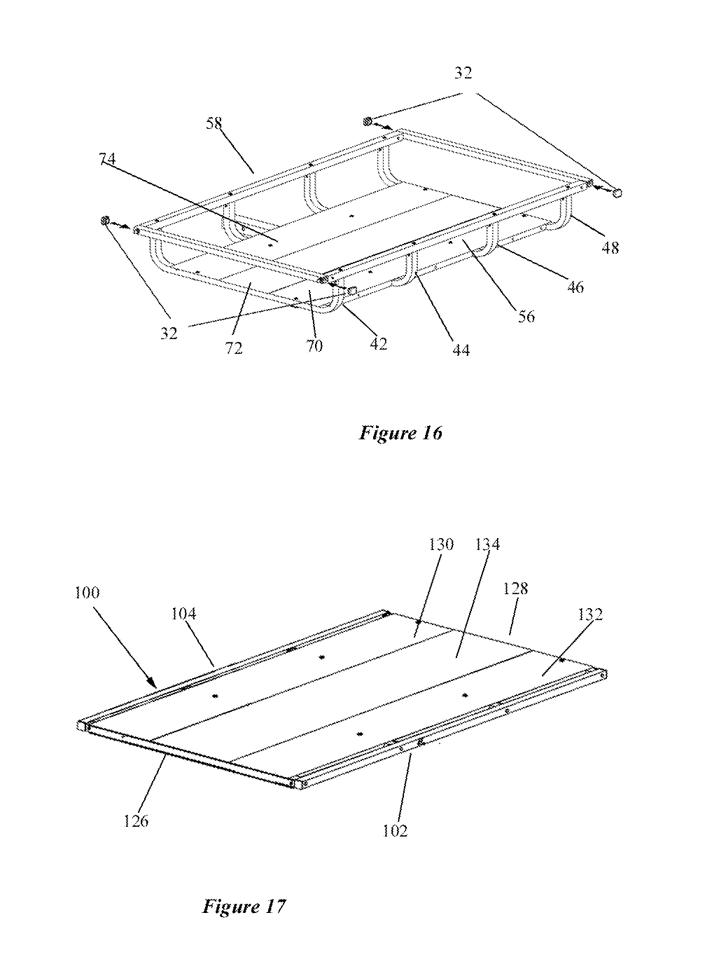

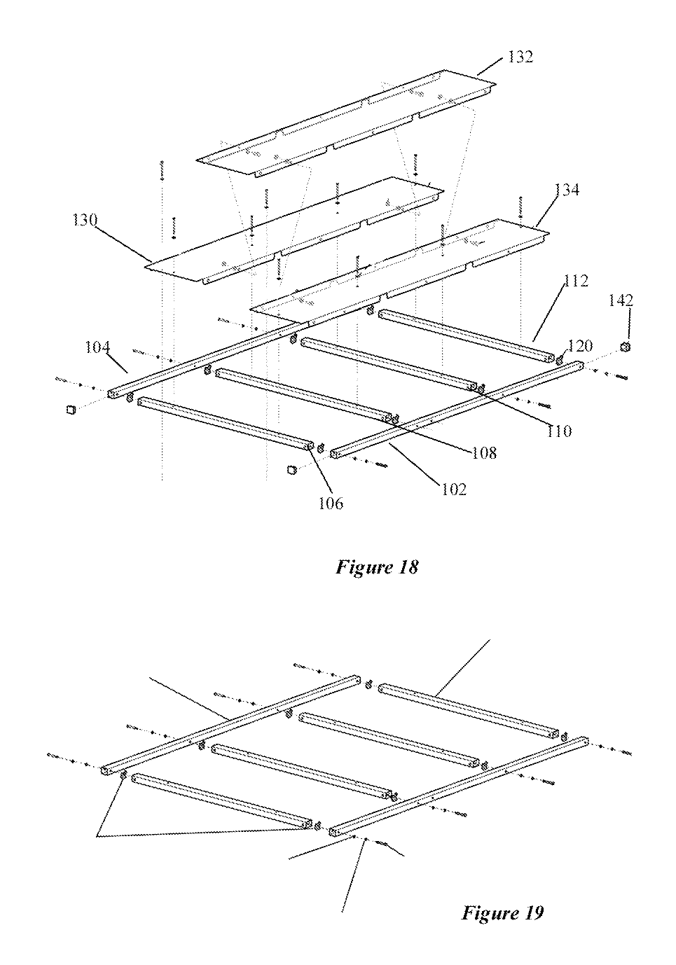

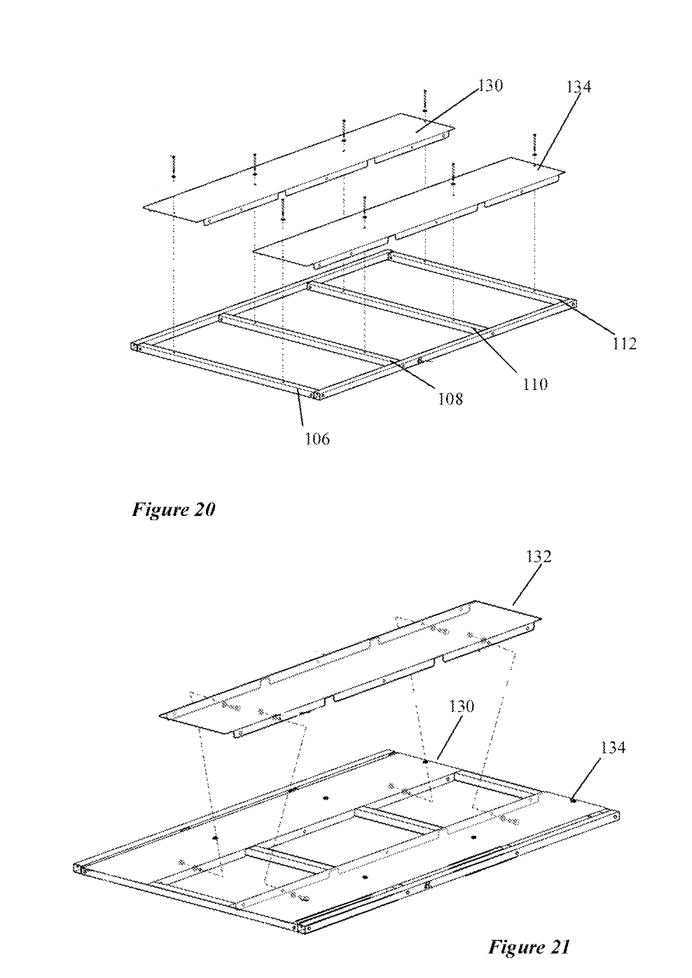

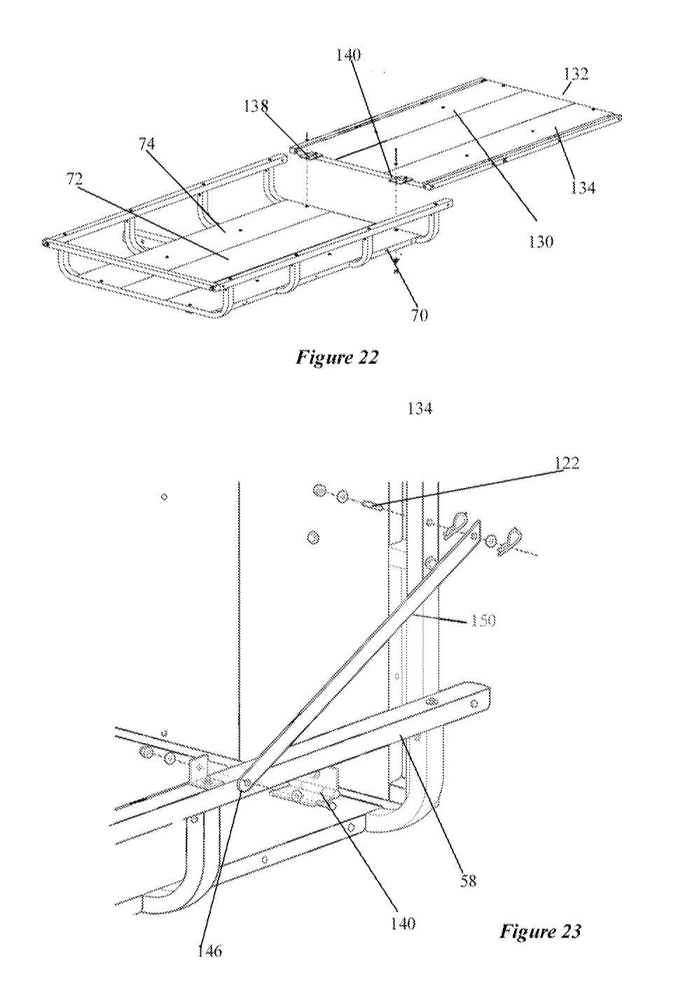

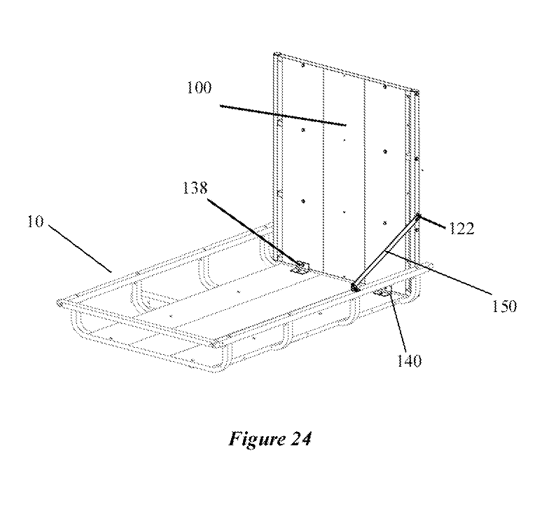

Another preferred embodiment of the securing mechanism is illustrated in FIGS. 12 and 13. This securing mechanism uses a square flanged nut 160 that is inserted into the open end of the tube member 42. The nut 160 includes holes 162, 164 extending through the flanges 166, 168 of the nut. A dowel pin 170 engages through holes in the tube member 42 and through the holes 162, 164 of the nut in the tube member 42. The bolt 150 is then inserted through a hole in the side tube member to engage in the threaded hole 172 of the nut 160 to secure the side tube member to the platform tube member.

Panels 70, 72, 74 are secured to the flat portions 76 of the platform members 42, 44, 46, 48 to form the floor of the platform 40. Each of the panels 70, 72, 74 include return flanges 78 along one edge of the panels. These return flanges 78 provide two important functions. First, the return flanges substantially stiffen the panels 70, 72, 74 and increase the strength and rigidity of the panels. This enables the panels to support an increased load. Secondly, the flanges provide surfaces to fasten the panels to one another. Bolts are secured through holes in the flanges to fasten the panels to the adjacent panel. Also, holes in the flanges provide tied down holes for securing loads. In this preferred embodiment, the outside panels 70, 74 are secured directly to the platform members 42, 44, 46, 48 and the cross tube members 20, 22 while the center panel 72 is secured to the outside panels 70, 74.

The assembled cargo carrier system 10 is relatively lightweight that enables it to be easily installed onto the vehicle receiver mount. The innovative use of the hollow tube members forming the cross members, the platform tube members, the side tube members and the end tube members form a high strength yet light weight structure. Cargo can be placed on the panel compartment floor between the end tube members and the side tube members. Securing straps can secure the cargo in place on the platform.

The components of the cargo carrier system can be packaged for knock down shipment as well as for storage. This enables the system to compactly inventoried as well as shipped directly to the consumer in an efficient manner. The components are easily assembled by most consumers with a minimum amount of tools and mechanical expertise.

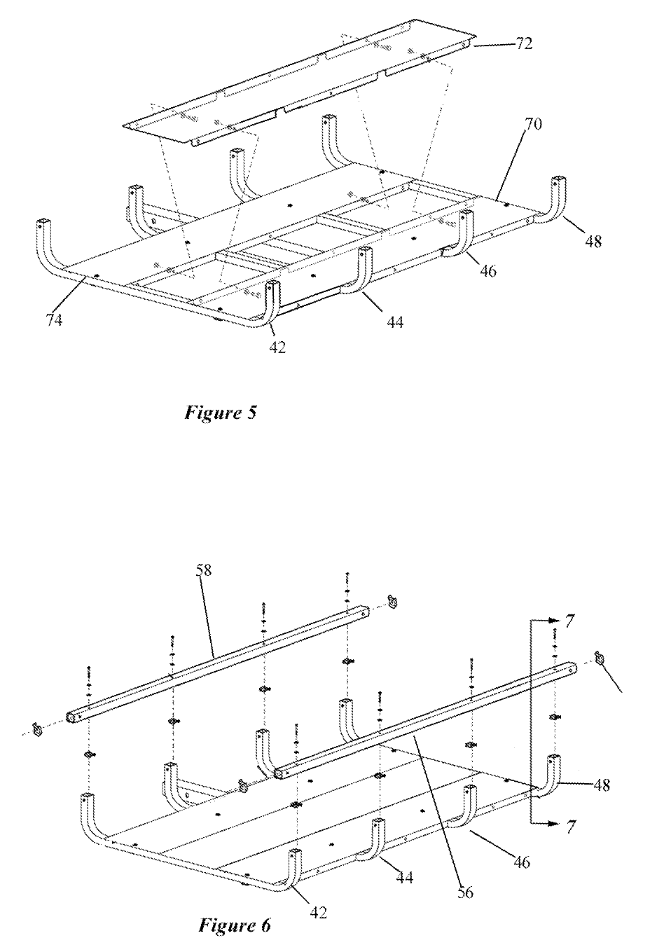

Another preferred embodiment of the present invention includes a ramp system 100 that is used in connection with the above carrier system or used with other devices including other cargo carriers, trailers, vehicle cargo beds or any other system that utilizes a ramp. The ramp system 100 is illustrated in FIGS. 5-7.

The ramp system 100 of this preferred embodiment includes side tubes 102, 104 and spaced parallel cross tube members 106, 108, 110, 112. In this preferred embodiment, the tubes 102, 104, 106, 108, 110, 112 are fabricated from standard hollow steel tubing, preferably one-half inch to one inch square tubing. It is to be expressly understood that other sizes of tubing, types of tubing, such as C or U shaped tubing and even materials, such as high strength plastic can be used as well. The lengths of the side tube members and the cross tube members is selected depending on the size of the ramp to be assembled.

The cross tube members 106, 108, 110, 112 are secured transversely to the side tube members 102, 104 by bolts 114 engaging in pin nuts 116 inserted in the cross tube members. Seal gaskets 120 may also be used between the side tube members and the cross tube members to form a secure engagement. Lynch pin member 122 is also attached to the side tube 104 as discussed in greater detail below. These assembled tubes form base tube assembly 124.

Base panels 130, 134 are attached to the base tube assembly 124 by bolts 134. These base panels are formed from flat sheet metal but other materials such as wood, plastic or other materials may be used as well. The flanges extending downwardly from one edge of each of the panels provide additional rigidity and strength as well as providing surfaces to fasten the panels to one another. Holes in the flanges also provide tied down holes for securing loads. Hinges 138, 140 are attached to one end of the base tube assembly 124 on top of the base panels 130, 134, respectively. Center base panel 133 is mounted between and to the base panels 130, 134. Plastic end caps 142 may be inserted into the ends of the side tube members 102, 104.

The assembled ramp 100 may then be used on trailers, vehicles, loading docks or other loading areas or any other use as other ramps. The ramp is relatively lightweight but high strength due to the use of the hollow structural tubing. It can accommodate such cargo as ATVs, motorcycles, lawn mowers, personal mobility scooters, wheel chairs and many other types of cargo.

In this preferred embodiment, the assembled ramp 100 is installed as an accessory to the cargo carrier system 10 in the above described embodiment. The end tube member 62 is removed from the side tube members of cargo carrier system 10. The width of the assembled ramp 100 is designed to fit closely with the side tube members 56, 58. The hinges 138, 140 of the assembled ramp 100 are fastened to the base panels 70, 74 and the end cross member 48 to attach the ramp 100 to the cargo carrier system 10.

Bracket 146 is attached to an upper surface of the side tube member 58. Stop lever 150 is attached to the bracket 146 for engagement with the lynch pin member 122 of the ramp 100. This secures the ramp from accidentally falling forward onto the cargo carrier or falling down away from the cargo carrier.

The ramp is easily lowered when needed by removing lynch pin 122 from stop lever 150. The ramp 100 of the preferred embodiment has a length to allow it to be at a shallow angle to allow cargo to be pushed, driven or pulled up the ramp onto the platform of the cargo carrier. The elevated sides of the cargo carrier retain the cargo on the carrier. The ramp is then raised to an upright position and secured by the lynch pin 122 engaging the stop lever to hold the ramp in the upright position.

Another preferred embodiment of the present invention uses a double shank attachment mechanism to increase the stability and load capacity of the cargo carrier system. For example, the platform 40 of the above embodiment may use a double shank system that engages a double tube design such as the cargo carrier system disclosed in U.S. patent application Ser. No. 09/683,820, incorporated by reference herein.

These and other embodiments of the present invention are considered to be within the scope of the claimed inventions.

1. A cargo carrier system for mounting to a vehicle, the cargo carrier system comprising:
a shank member for insertion into the receiver mount of a vehicle;
at least one cross member secured transversely to said shank member;
at least one platform tube member secured to said at least one cross member and extending substantially parallel to said shank member; and
at least one platform panel mounted to said at least one platform tube member.

2. The cargo carrier system of claim 1 wherein said at least one platform tube member includes:
a hollow structural tube.

3. The cargo carrier system of claim 1 wherein said at least one platform tube member includes:
a hollow structural tube having a central straight portion and upwardly extending end portions.

4. The cargo carrier system of claim 1 wherein said at least one platform tube member includes:
a plurality of platform tube members mounted to said at least one cross member in spaced relationship to one another.

5. The cargo carrier system of claim 1 wherein said cargo carrier system includes:
a plurality of platform tube members mounted to said at least one cross member in spaced relationship to one another; and
a first side rail member secured to each of the first end of said platform tube members; and
a second side rail member secured to each of the second end of said platform tube members;

6. The cargo carrier system of claim 1 wherein said cargo carrier system includes:
a plurality of platform tube members mounted to said at least one cross member in spaced relationship to one another; and
a first side rail member secured to each of the first end of said platform tube members;
a second side rail member secured to each of the second end of said platform tube member;
a first end member secured to each of the first ends of said first side rail member and said second side rail member; and
a second end member secured to each of the second ends of said first side rail member and said second side rail member.

7. The cargo carrier system of claim 1 wherein cargo carrier system further includes:
said shank member, said at least one cross member, said at least one platform tube member and said at least one panel are shipped unassembled with mounting mechanisms for securing said shank member, said at least one cross member, said at least one platform tube member and said at least one panel to one another.

8. The cargo carrier system of claim 1 wherein said cargo carrier system further includes:
a ramp mountable to one end of said cargo carrier system.

9. The cargo carrier system of claim wherein said cargo carrier system further includes:
a ramp mountable to one end of said cargo carrier system wherein said ramp includes:
a first side rail member;
a second side rail member;
at least one cross member mounted between said first side rail member and said second rail member; and
at least one panel secured to said at least one cross member.

10. The cargo carrier system of claim 9 wherein said cargo carrier system further includes:
a hinge mechanism for pivotally mounting said ramp to said cargo carrier system.

11. The cargo carrier system of claim 1 wherein said cargo carrier system further includes:
a pin nut mechanism for securing said at least one cross tube member to said at least one side tube member, wherein said pin nut mechanism includes a pin insertable in holes of said at least one cross tube member and a threaded portion in said pin for receiving a bolt inserted through said at least one side tube member.

12. A ramp system, said ramp system comprising:
a first side rail member;
a second side rail member;
at least one cross member mounted between said first side rail member and said second rail member; and
at least on panel secured to said at least one cross member.

13. The ramp system of claim 12 wherein said ramp system further includes:
a mounting mechanism for mounting said ramp system to a cargo carrier system.

14. The ramp system of claim 12 wherein said ramp system further includes:
a hinge mechanism for pivotally mounting said ramp system to a cargo carrier system.

15. The ramp system of claim 12 wherein said ramp system further includes:
a mounting mechanism for mounting said ramp system to a cargo carrier system, wherein said cargo carrier system includes:
a shank member for insertion into the receiver mount of a vehicle;
at least one cross member secured transversely to said shank member;
at least one platform tube member secured to said at least one cross member and extending substantially parallel to said shank member; and
at least one platform panel mounted to said at least one platform tube member.

16. A cargo carrier system, wherein said cargo carrier system comprises:
a shank member for insertion into the receiver mount of a vehicle;
at least one cross member secured transversely to said shank member;
at least one platform tube member secured to said at least one cross member and extending substantially parallel to said shank member;
at least one platform panel mounted to said at least one platform tube member
a ramp system mounted onto said cargo carrier system wherein said ramp system includes: a first side rail member;
a second side rail member;
at least one cross member mounted between said first side rail member and said second rail member; and
at least on panel secured to said at least one cross member.
